(19) United States
(12) Patent Application Publication
(10) Pub. No.: US 2017/0067399 A1
(43) Pub. Date: Mar. 9, 2017

(54) METHOD OF CONTROLLING CVVT

(71) Applicants: HYUNDAI MOTOR COMPANY, Seoul (KR); KIA MOTORS CORPORATION, Seoul (KR)

(72) Inventors: Sung Joo KIM, Seoul (KR); Do Geun JUNG,, Suwon-si (KR)

(73) Assignees: KIA MOTORS CORPORATION, Seoul (KR); HYUNDAI MOTOR COMPANY, Seoul (KR)

(21) Appl. No.: 14/945,076

(22) Filed: Nov. 18, 2015

(30) Foreign Application Priority Data
Sep. 3, 2015 (KR) 10-2015-0124703

(51) Int. Cl. F02D 13/02

(52) U.S. Cl. CPC F02D 13/02

(57) ABSTRACT

A method of controlling a CVVT includes: a very low temperature condition deciding step of deciding whether or not an engine is in a very low temperature condition state on the basis of information received from the engine at the time of starting up a vehicle in a controlling unit; an operation number confirming step of confirming the number of operations of the CVVT after starting up the vehicle when the engine is in the very low temperature condition state; and a very low temperature condition applying step of applying a very low temperature condition at the time of controlling the CVVT when the number of operations of the CVVT after starting up the vehicle is less than a predetermined number input to the controlling unit.

### CROSS-REFERENCE TO RELATED APPLICATION

The present application claims the benefit of Korean Patent Application No. 10-2015-0124703, filed on Sep. 3, 2015, which is incorporated herein by reference in its entirety.

### FIELD

The present disclosure relates to a method of controlling a continuously variable valve timing (CVVT).

### BACKGROUND

The statements in this section merely provide background information related to the present disclosure and may not constitute prior art.

Generally, a continuously variable valve timing (CVVT) is used in a vehicle in order to decrease an exhaust gas and improve fuel efficiency and an output. Recently, we have discovered a limitation in responsibility and an operation region of a CVVT system, and the development of an intermediate phase CVVT system in which the above-mentioned limitation is improved has been conducted. In the case of the intermediate phase CVVT, a control is performed at an intermediate position of a cam rather than maximum lag angle (intake) and maximum advance angle (exhaust) positions, such that responsibility may be rapid and a use region of the cam may be widened, thereby improving fuel efficiency and decreasing an exhaust gas.

Meanwhile, a lock pin of the intermediate phase CVVT installed at a rotor side is locked to a lock pin hole positioned between an advance angle chamber and a lag angle chamber in a process in which a revolution per minute (RPM) of an engine is decreased, thereby preparing for start-up of the engine later. Here, a state in which the lock pin is automatically locked to the lock pin hole in the process in which the RPM of the engine is decreased is called a ‘self-lock’ state.

The self-lock is a function capable of allowing the CVVT to return to a mechanically accurate position without performing a separate manipulation so that driving stability of the engine may be maintained in a region other than an operation region of the CVVT, that is, in an idle driving state of the vehicle or at the time of starting up the vehicle.

However, we have discovered that when a valve timing does not return to an intermediate phase, but moves to the maximum lag angle position, a vacuum is not formed in a surge tank at the time of idle-driving the vehicle, and a pressure in the surge tank rises up to an atmospheric pressure level, such that brake performance using the vacuum in the surge tank is deteriorated.

In addition, when the valve timing does not return to the intermediate phase, but moves to the maximum advance angle position, a valve timing overlap between an intake valve and an exhaust valve is excessively generated, such that the driving stability of the engine is deteriorated, vibrations of the engine are increased, and an engine stall problem occurs in some cases.

That is, in the intermediate phase CVVT, when a so-called self-lock function of the lock pin is not automatically performed, such that the rotor and the lock pin are put at the maximum advance angle or maximum lag angle position, the engine stall problem and a problem in which a negative pressure is not appropriately formed, such that a brake is not operated occur.

The CVVT is configured to be operated when a predetermined condition is satisfied. Generally, an operation condition is set on the basis of surrounding environments (e.g., a coolant temperature, an oil temperature, and the like) of a CVVT module. However, substantially, it is difficult for these to speak for environments in the CVVT module. Therefore, in the case in which the vehicle is put in a very low temperature environment, even though a state of the engine, and the like, satisfies an operation condition under which the CVVT may be operated, such that a controlling unit gives a command to operate the CVVT, although a coolant, an engine oil, an engine body, and the like, are actually heated by combustion heat of the engine, heating speeds, transfer amounts of the combustion heat of the engine, cooling amounts due to an external condition are different from each other, such that a case in which the CVVT is still in a low temperature state and is not operated occurs.

That is, since a mounting position of the CVVT module may be disadvantageous in transferring the combustion heat of the engine and the CVVT module is directly exposed to the outside, such that the largest cooling due to an external temperature (a temperature of an engine room) is generated, even though the controlling unit simply decides that the CVVT may be controlled on the basis of a temperature of the engine to attempt to drive the CVVT, the CVVT is not actually operated due to a very low external temperature. Therefore, a temperature of the CVVT module and a decision condition for a CVVT operation condition are different from each other at a very low temperature, such that problems such as warning light generation, EM deterioration, drivability deterioration, and the like, occur.

### SUMMARY

The present disclosure provides a method of controlling a continuously variable valve timing (CVVT) capable of reducing or preventing occurrence of problems such as warning light generation, EM deterioration, drivability deterioration, and the like, by detecting and controlling an actual temperature of a CVVT module in the case in which a vehicle is put in a very low temperature environment.

According to one form of the present disclosure, there is provided a method of controlling a CVVT, including: a very low temperature condition deciding step of deciding whether or not an engine is in a very low temperature condition state on the basis of information received from the engine at the time of starting up a vehicle in a controlling unit; an operation number confirming step of confirming the number of operations of the CVVT after starting up the vehicle when it is decided in the very low temperature condition deciding step that the engine is in the very low temperature condition state; and a very low temperature condition applying step of applying a very low temperature condition at the time of controlling the CVVT when it is confirmed in the operation number confirming step that the number of operations of the CVVT after starting up the vehicle is less than a predetermined number input to the controlling unit.

In the very low temperature condition deciding step, it may be decided whether or not the engine is in the very low temperature condition state on the basis of one or more of a coolant temperature at the time of starting up the vehicle, a soaking time, and an oil temperature at the time of starting up the vehicle.

In the very low temperature condition deciding step, it may be decided that the engine is in the very low temperature condition state when the coolant temperature at the time of starting up the vehicle is equal to or smaller than a predetermined reference value pre-stored in the controlling unit.

In the very low temperature condition deciding step, it may be decided that the engine is in the very low temperature condition state when the soaking time is equal to or larger than a predetermined reference value pre-stored in the controlling unit.

In the very low temperature condition deciding step, it may be decided that the engine is in the very low temperature condition state when the oil temperature at the time of starting up the vehicle is equal to or smaller than a predetermined reference value pre-stored in the controlling unit.

When it is decided in the very low temperature condition deciding step that the engine is not in the very low temperature condition state, a general condition applying step of applying a general CVVT operation condition may be performed.

In the operation number confirming step, when it is confirmed that the number of operations of the CVVT after starting up the vehicle is equal to or larger than a reference value input to the controlling unit, a general condition applying step of applying a general CVVT operation condition may be performed.

After the operation number confirming step, a CVVT operation condition deciding step of deciding whether or not conditions for operating the CVVT are satisfied may be performed.

When it is decided in the CVVT operation condition deciding step that the conditions for operating the CVVT are satisfied, a CVVT operating step of operating the CVVT may be performed.

When it is decided in the CVVT operation condition deciding step that the conditions for operating the CVVT are not satisfied, the CVVT operation condition deciding step may be again performed repeatedly without operating the CVVT.

According to another form of the present disclosure, there is provided a method of controlling a CVVT in which the number of operations of the CVVT after starting up a vehicle is confirmed when it is decided that an engine is in a very low temperature condition state on the basis of information received from the engine at the time of starting up the vehicle and it is decided that the engine is in the very low temperature condition state when the number of operations of the CVVT is less than a predetermined reference value, thereby applying the very low temperature condition to a control of the CVVT at the time of controlling the CVVT.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a flow chart illustrating a method of controlling a continuously variable valve timing (CVVT) according to one form of the present disclosure; and

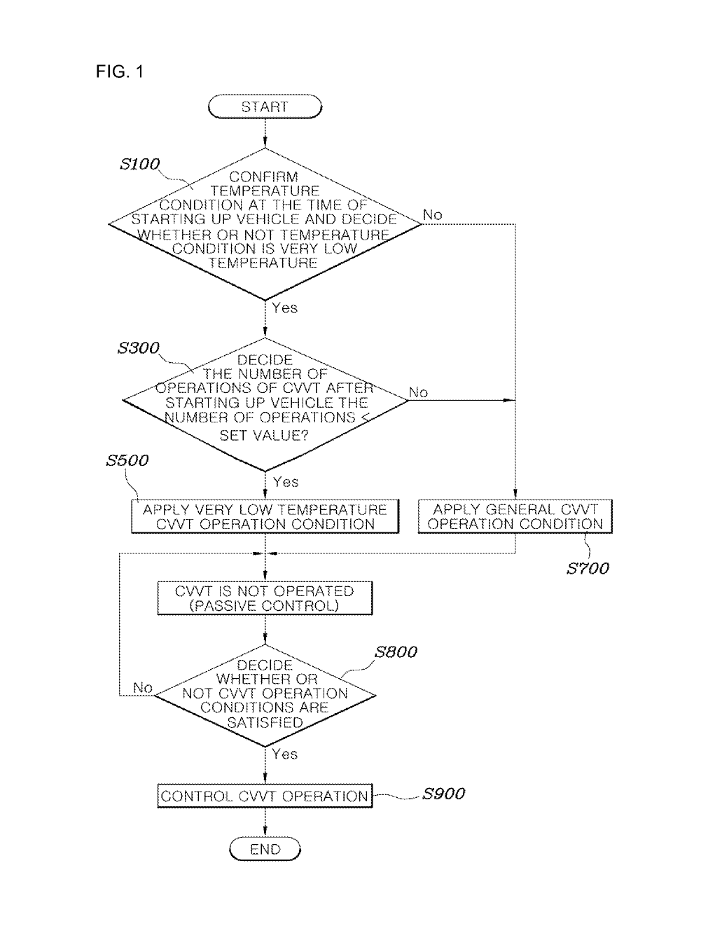

FIG. 2 is a block diagram illustrating components for performing the method of controlling a CVVT of FIG. 1.

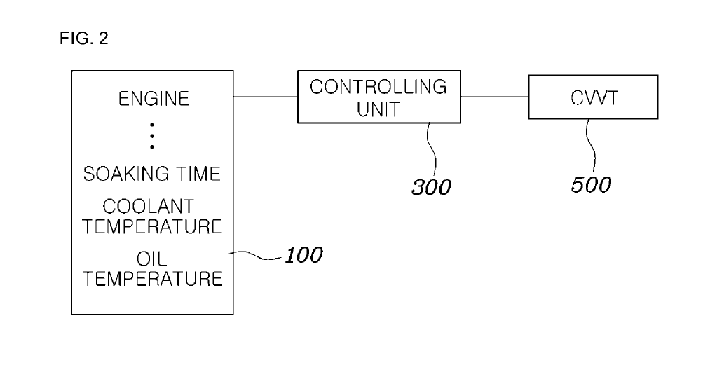

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The method of controlling a CVVT according to one form of the present disclosure includes: a very low temperature condition deciding step (S100) of deciding whether or not an engine 100 is in a very low temperature condition state on the basis of information received from the engine 100 at the time of starting up a vehicle in a controlling unit 300; an operation number confirming step (S300) of confirming the number of operations of the CVVT 500 after starting up the vehicle when it is decided in the very low temperature condition deciding step (S100) that the engine is in the very low temperature condition state; and a very low temperature condition applying step (S500) of applying a very low temperature condition at the time of controlling the CVVT 500 when it is confirmed in the operation number confirming step (S300) that the number of operations of the CVVT 500 after starting up the vehicle is less than a predetermined number input to the controlling unit 300.

In the present disclosure, it is decided whether or not an environment in which the vehicle is put is the very low temperature condition state, and it is decided that a general condition and a very low temperature condition are different from each other at the time of controlling the CVVT 500, thereby performing reflection and a control. That is, a condition for deciding whether or not the vehicle is in a very low temperature situation at the time of being started up is inserted into a logic, such that a control is performed under dualized decision conditions so that the control is differently performed in the case in which the vehicle is in the very low temperature situation and in the case in which the vehicle is in a general situation.

In the very low temperature condition deciding step (S100), it is decided whether or not the engine 100 is in the very low temperature condition state on the basis of the information received from the engine 100. Here, references for deciding whether or not the engine 100 is in the very low temperature condition state may be a coolant temperature at the time of starting up the vehicle, a soaking time, and an oil temperature at the time of starting up the vehicle, and it is decided whether or not the engine 100 is in the very low temperature condition state on the basis of one or more of these references. That is, in the very low temperature condition deciding step (S100), it is decided that the engine 100 is in the very low temperature condition state when the coolant temperature at the time of starting up the vehicle is equal to or smaller than a predetermined reference value pre-stored in the controlling unit 300. In the very low temperature condition deciding step (S100), it is decided that the engine 100 is in the very low temperature condition state when the soaking time is equal to or larger than a predetermined reference value pre-stored in the controlling unit 300. In addition, in the very low temperature condition deciding step (S100), it is decided that the engine 100 is in the very low temperature condition state when the oil temperature at the time of starting up the vehicle is equal to or smaller than a predetermined reference value pre-stored in the controlling unit 300. These reference indices are not limited to the above-mentioned three conditions. That is, decision reference conditions may be added, deleted, and modified without limit depending on a design or an environment of the vehicle.

In the case in which it is decided in the very low temperature condition deciding step (S100) that the engine 100 is not in the very low temperature condition state when decision references transferred to the controlling unit 300 at the time of starting up the vehicle are compared with reference values input to the controlling unit 300, a general condition applying step (S700) of applying a general CVVT operation condition is performed.

In the operation number confirming step (S300), the number of operations of the CVVT 500 after starting up the vehicle is counted within one driving cycle when it is decided in the very low temperature condition deciding step (S100) that the engine 100 is in the very low temperature condition state. Here, when it is confirmed that the number of operations of the CVVT 500 after starting up the vehicle is equal to or larger than a reference value input to the controlling unit 300, the general condition applying step (S700) of applying a general condition to control the CVVT 500 is performed. The reason why the general condition is applied as described above is that even though the vehicle is put in the very low temperature condition state, the operations of the CVVT 500 are repeatedly performed, such that it is decided that a difference between the CVVT 500 and the CVVT decision conditions is offset.

After the operation number confirming step (S300), a CVVT operation condition deciding step (S800) of deciding whether or not conditions for operating the CVVT 500 are satisfied is performed, and when it is decided in the CVVT operation condition deciding step (S800) that the conditions for operating the CVVT 500 are satisfied, a CVVT operating step (S900) of operating the CVVT 500 is performed. However, when it is decided in the CVVT operation condition deciding step (S800) that the conditions for operating the CVVT 500 are not satisfied, the CVVT operation condition deciding step (S800) is again performed repeatedly without operating the CVVT 500.

In the present disclosure, the method of controlling a CVVT in which the number of operations of the CVVT 500 after starting up the vehicle is confirmed when it is decided that the engine is in the very low temperature condition state on the basis of the information received from the engine 100 at the time of starting up the vehicle and it is decided that the engine is in the very low temperature condition state when the number of operations of the CVVT 500 is less than a predetermined reference value, thereby applying the very low temperature condition to the control of the CVVT 500 at the time of controlling the CVVT 500 is disclosed.

As described above, in the method of controlling a CVVT according to one form of the present disclosure, in the CVVT system, the very low temperature condition state and the general condition are distinguished from each other to be applied to the control of the CVVT, thereby making it possible to reduce or prevent occurrence of a control defect problem due to a difference between a temperature condition of the engine and a temperature condition of the CVVT. Therefore, occurrence of problems such as a responsibility decrease, drivability deterioration, warning light generation, and the like, due to a control defect of the CVVT may be prevented or reduced in advance. In addition, the method of controlling a CVVT may be applied to mass production of an existing general CVVT as well as an intermediate phase CVVT.

Although the present disclosure has been illustrated and described with respect to specific forms, it will be obvious to those skilled in the art that the present disclosure may be variously modified and altered without departing from the spirit and scope of the present disclosure as defined by the following claims.

What is claimed is:

1. A method of controlling a continuously variable valve timing (CVVT), comprising:
a very low temperature condition deciding step of deciding, by a controlling unit, whether an engine is in a very low temperature condition state based on information received from the engine at a time of starting up a vehicle;
an operation number confirming step of confirming a number of operations of the CVVT after starting up the vehicle when the engine is in the very low temperature condition state; and
a very low temperature condition applying step of applying a very low temperature condition at a time of controlling the CVVT when the number of operations of the CVVT after starting up the vehicle is less than a predetermined number input to the controlling unit.

2. The method of claim 1, wherein in the very low temperature condition deciding step, the very low temperature condition state is determined based on one or more of a coolant temperature at the time of starting up the vehicle, a soaking time, and an oil temperature at the time of starting up the vehicle.

3. The method of claim 2, wherein in the very low temperature condition deciding step, the very low temperature condition state is decided when the coolant temperature at the time of starting up the vehicle is equal to or smaller than a predetermined reference value pre-stored in the controlling unit.

4. The method of claim 2, wherein in the very low temperature condition deciding step, the very low temperature condition state is decided when the soaking time is equal to or larger than a predetermined reference value pre-stored in the controlling unit.

5. The method of claim 2, wherein in the very low temperature condition deciding step, the very low temperature condition state is decided when the oil temperature at the time of starting up the vehicle is equal to or smaller than a predetermined reference value pre-stored in the controlling unit.

6. The method of claim 1, wherein a general condition applying step of applying a general CVVT operation condition is performed when the engine is not in the very low temperature condition state.

7. The method of claim 1, wherein in the operation number confirming step, when the number of operations of the CVVT after starting up the vehicle is equal to or larger than a reference value input to the controlling unit, a general condition applying step of applying a general CVVT operation condition is performed.

8. The method of claim 1, wherein after the operation number confirming step, a CVVT operation condition deciding step of deciding whether conditions for operating the CVVT are satisfied is performed.

9. The method of claim 8, wherein when the conditions for operating the CVVT are satisfied, a CVVT operating step of operating the CVVT is performed.

10. The method of claim 8, wherein when the conditions for operating the CVVT are not satisfied, the CVVT operation condition deciding step is repeatedly performed without operating the CVVT.

11. A method of controlling a continuously variable valve timing (CVVT) in which a number of operations of the CVVT after starting up a vehicle is confirmed by a controlling unit when an engine is in a very low temperature condition state based on information received from the engine at a time of starting up the vehicle, the method comprising:
deciding that the engine is in the very low temperature condition state when the number of operations of the CVVT is less than a predetermined reference value; and
applying a very low temperature condition to a control of the CVVT at a time of controlling the CVVT.
